(19) United States
(12) Patent Application Publication
(10) Pub. No.: US 2015/0219804 A1
(43) Pub. Date: Aug. 6, 2015

(54) HEAT RADIATION CONTROL ELEMENT AND PRODUCTION METHOD THEREOF

(71) Applicant: DEXERIALS CORPORATION, Tokyo (JP)

(72) Inventors: Takatoshi Yamada, Tokyo (JP); Koji Sasaki, Tokyo (JP); Akio Takada, Tokyo (JP); Yusuke Matsuno, Tokyo (JP)

(21) Appl. No.: 14/613,100

(22) Filed: Feb. 3, 2015

(30) Foreign Application Priority Data
Feb. 4, 2014 (JP) 2014-019571
Dec. 5, 2014 (JP) 2014-246939

(51) Int. Cl. G02B 5/08

(52) U.S. Cl. CPC G02B 5/0816; G02B 5/0858

(57) ABSTRACT

A heat radiation control element 11, which contains an inorganic layer 21 a surface of which has openings arranged two-dimensionally, and a reflecting film 22.

### BACKGROUND OF THE INVENTION

1. Field of the Invention

The present invention relates to a heat radiation control element used for spacecraft device, such as an artificial satellite, and a production method thereof.

2. Description of the Related Art

A heat radiation control element called an optical solar reflector (OSR) is used for a device for space exploration, such as an artificial satellite (see, for example, Japanese Patent Application Laid-Open (JP-A) No. 05-77799). The OSR is configured to reflect sun light rays applied to the device for space exploration, and to emit self-generated heat of the device for space exploration to the space to prevent heat generation of the device for space exploration.

FIG. 36 is a schematic cross-sectional view illustrating a structural example of a conventional heat radiation control element. As illustrated in FIG. 36, the OSR provided on the satellite surface 103 typically has a structure where a reflecting film 102, such as Ag is applied to a back surface of a quartz substrate 101. The incident sun light passes through the quartz substrate 101, and most of the incident light is reflected by the reflecting film 102 to be emitted outside with again passing through the quartz substrate 101. Moreover, radiation of heat in the infrared light region is efficiently performed with the quartz substrate 101. Therefore, as for the properties of the OSR, low sun light absorption coefficient, and high radiative coefficient are desired.

The ideal value of the radiative coefficient is better, as it is closer to 1. However, the normal emittance (∈ₙ) at 300° K is about 0.845 with a conventional OSR structure. Quartz has relatively high emittance in the infrared light region, but the emittance thereof is low in the peak wavelength region of the black-body radiation at 300° K. This is due to the properties unique to the quartz substrate, and hence it has been difficult to increase the radiative coefficient of OSR.

### SUMMARY OF THE INVENTION

The present invention is proposed based upon the aforementioned situation in the art, and aims to provide a heat radiation control element having excellent thermal radiation properties, and a production method thereof.

In order to solve the aforementioned problems, the heat radiation control element of the present invention contains an inorganic layer a surface of which has openings arranged two-dimensionally, and a reflecting film, in which the inorganic layer is either a quartz layer, or a glass layer.

Moreover, the production method of a heat radiation control element according to the present invention contains: forming a resist pattern, in which predetermined shapes are two-dimensionally arranged, on a surface of an inorganic substrate, which is either a quartz substrate or a glass substrate; etching the surface of the inorganic substrate using the resist pattern as a mask to form two-dimensionally arranged openings at the surface of the inorganic substrate; and forming a reflecting film on a surface of the inorganic substrate that is opposite to the surface thereof where the openings are formed through vacuum deposition or sputtering.

Furthermore, the production method of a heat radiation control element according to the present invention contains: laminating a dielectric film, a reflecting film, and a protective film in this order on one surface of an inorganic substrate that is either a quartz substrate or a glass substrate; forming a transparent conductive film on another surface of the inorganic substrate; forming a resist pattern, in which predetermined shapes are two-dimensionally arranged, on a surface of the transparent conductive film; and etching the surface of the inorganic substrate using the resist pattern as a mask to form two-dimensionally arranged openings at the surface of the inorganic substrate.

According to the present invention, the emittance of a certain wavelength region due to properties unique to a quartz substrate or glass substrate is improved by openings that are two-dimensionally arranged at a surface of the quartz or glass, and excellent thermal radiation properties can be obtained.

### BRIEF DESCRIPTION OF THE DRAWINGS

FIG. 1 is a schematic cross-sectional view illustrating a first structural example of the heat radiation control element.

FIG. 2 is a schematic perspective view illustrating a structural example of the heat radiation control elements where shapes of the openings are squares.

FIG. 3 is a schematic cross-sectional view illustrating a second structural example of the heat radiation control element.

FIG. 4 is a schematic cross-sectional view illustrating a third structural example of the heat radiation control element.

FIG. 5 is a schematic cross-sectional view illustrating a fourth structural example of the heat radiation control element.

FIG. 6 is a graph depicting the emittance of quartz, and a black-body radiation spectrum.

FIG. 7 is a graph depicting the refractive index of quartz.

FIG. 8 is a graph depicting the emittance, when it is assumed that there is no dispersion therein.

FIG. 9 is a graph depicting the emittance, when cavities are formed at a surface of the quartz.

FIG. 10 is a graph depicting the emittance of a sample, in which cavities are formed at a surface of glass.

FIG. 11A is a planar photograph depicting openings, opening shapes of which are circles.

FIG. 11B is a 45°-diagonal photograph depicting openings, opening shapes of which are circles.

FIG. 12 is a graph depicting emittance, when widths of cavities formed at a surface of quartz are 2.5 μm, 3.0 μm, 4.5 μm, 6.0 μm, 8.0 μm, and 11.0 μm.

FIG. 13 is a graph depicting the normal emittance (300° K) relative to widths of cavities formed at a surface of quartz.

FIG. 14 is a graph depicting the emittance, when depths of cavities formed at a surface of quartz are 0 μm (a flat surface), 0.7 μm, 1.75 μm, and 3.5 μm.

FIG. 15 is a graph depicting the normal emittance (300° K) relative to depths of cavities formed at a surface of quartz.

FIG. 16 is a cross-sectional view schematically illustrating an electric field within a cavity, when an imaginary part is infinite.

FIG. 17 is a cross-sectional view schematically illustrating an electric field within a cavity, when an imaginary part is finite.

FIG. 18A is a top view illustrating cavities, opening shapes of which are squares.

FIG. 18B is a top view illustrating cavities, opening shapes of cavities which are circles.

FIG. 19A is a top view illustrating cavities, which are arranged in a lattice arrangement.

FIG. 19B is a top view illustrating cavities, which are arranged in a houndstooth arrangement.

FIG. 20 is a graph depicting emittance, when opening shapes of cavities are circles, and depths of the cavities are 0 μm (a flat surface), 0.5 μm, 2.0 μm, and 3.0 μm.

FIG. 21 is a planar photograph of an actual sample, the sample No. 11 (pitch: 4.5 μm, cavity diameter: 3.0 μm, and cavity depth: 3.5 μm).

FIG. 22 is a planar photograph of an actual sample, the sample No. 13 (pitch: 4.5 μm, cavity diameter: 4.0 μm, and cavity depth: 3.5 μm).

FIG. 23 is a planar photograph of an actual sample, the sample No. 14 (pitch: 9.0 μm, cavity diameter: 6.0 μm, and cavity depth: 6.5 μm).

FIG. 24 is a planar photograph of an actual sample, the sample No. 16 (pitch: 9.0 μm, cavity diameter: 8.0 μm, and cavity depth: 6.5 μm).

FIG. 25 is a graph depicting the emittance of a sample where cavities are formed at a surface of quartz.

FIG. 26A is a cross-sectional view illustrating a step of the production method of a heat radiation control element, according to the first embodiment (part 1).

FIG. 26B is a cross-sectional view illustrating a step of the production method of a heat radiation control element, according to the first embodiment (part 2).

FIG. 26C is a cross-sectional view illustrating a step of the production method of a heat radiation control element, according to the first embodiment (part 3).

FIG. 26D is a cross-sectional view illustrating a step of the production method of a heat radiation control element, according to the first embodiment (part 4).

FIG. 26E is a cross-sectional view illustrating a step of the production method of a heat radiation control element, according to the first embodiment (part 5).

FIG. 26F is a cross-sectional view illustrating a step of the production method of a heat radiation control element, according to the first embodiment (part 6).

FIG. 27A is a cross-sectional view illustrating a step of the production method of a heat radiation control element, according to another embodiment (part 1).

FIG. 27B is a cross-sectional view illustrating a step of the production method of a heat radiation control element, according to another embodiment (part 2).

FIG. 27C is a cross-sectional view illustrating a step of the production method of a heat radiation control element, according to another embodiment (part 3).

FIG. 27D is a cross-sectional view illustrating a step of the production method of a heat radiation control element, according to another embodiment (part 4).

FIG. 27E is a cross-sectional view illustrating a step of the production method of a heat radiation control element, according to another embodiment (part 5).

FIG. 27F is a cross-sectional view illustrating a step of the production method of a heat radiation control element, according to another embodiment (part 6).

FIG. 27G is a cross-sectional view illustrating a step of the production method of a heat radiation control element, according to another embodiment (part 7).

FIG. 27H is a cross-sectional view illustrating a step of the production method of a heat radiation control element, according to another embodiment (part 8).

FIG. 28 is a planar photograph depicting openings shapes of cavities, which are circles having sizes of 4.6 μm in the pitch, 3.2 μm in the diameter, and 2.1 μm in the depth.

FIG. 29 is a 45°-diagonal photograph depicting openings shapes of cavities, which are circles having sizes of 4.6 μm in the pitch, 3.2 μm in the diameter, and 2.1 μm in the depth.

FIG. 30 is a 45°-diagonal enlarged photograph depicting openings shapes of cavities, which are circles having sizes of 4.6 μm in the pitch, 3.2 μm in the diameter, and 2.1 μm in the depth.

FIG. 31 is a cross-sectional photograph depicting openings shapes of cavities, which are circles having sizes of 4.6 μm in the pitch, 3.2 μm in the diameter, and 2.1 μm in the depth.

FIG. 32 is a planar photograph depicting openings shapes of cavities, which are circles having sizes of 4.6 μm in the pitch, 3.9 μm in the diameter, and 3.5 μm in the depth.

FIG. 33 is a 45°-diagonal photograph depicting openings shapes of cavities, which are circles having sizes of 4.6 μm in the pitch, 3.9 μm in the diameter, and 3.5 μm in the depth.

FIG. 34 is a 45°-diagonal enlarged photograph depicting openings shapes of cavities, which are circles having sizes of 4.6 μm in the pitch, 3.9 μm in the diameter, and 3.5 μm in the depth.

FIG. 35A is a cross-sectional view illustrating a step of the production method of a heat radiation control element, according to the second embodiment (part 1).

FIG. 35B is a cross-sectional view illustrating a step of the production method of a heat radiation control element, according to the second embodiment (part 2).

FIG. 35C is a cross-sectional view illustrating a step of the production method of a heat radiation control element, according to the second embodiment (part 3).

FIG. 35D is a cross-sectional view illustrating a step of the production method of a heat radiation control element, according to the second embodiment (part 4).

FIG. 35E is a cross-sectional view illustrating a step of the production method of a heat radiation control element, according to the second embodiment (part 5).

FIG. 35F is a cross-sectional view illustrating a step of the production method of a heat radiation control element, according to the second embodiment (part 6).

FIG. 35G is a cross-sectional view illustrating a step of the production method of a heat radiation control element, according to the second embodiment (part 7).

FIG. 35H is a cross-sectional view illustrating a step of the production method of a heat radiation control element, according to the second embodiment (part 8).

FIG. 35I is a cross-sectional view illustrating a step of the production method of a heat radiation control element, according to the second embodiment (part 9).

FIG. 36 is a schematic cross-sectional view illustrating a structural example of a conventional heat radiation control element.

### DETAILED DESCRIPTION OF THE INVENTION

The embodiment of the present invention is specifically explained in the following order, hereinafter.

### 1. Heat Radiation Control Element

1-1. General description of the present technology

1-2. Radiation properties unique to inorganic (quartz and glass) substrate

1-3. Resonance of cavities at metal surface

1-4. Resonance of cavities at inorganic (quartz and glass) surface

1-5. Widths of cavities

1-6. Depths of cavities

1-7. Pitch of cavities

1-8. Shapes of cavities

### 2. Production Method of Heat Radiation Control Element

2-1. First embodiment

2-2. Second embodiment

2-3. Another embodiment

### 1. Heat Radiation Control Element

### 1-1. General Description of the Present Technology

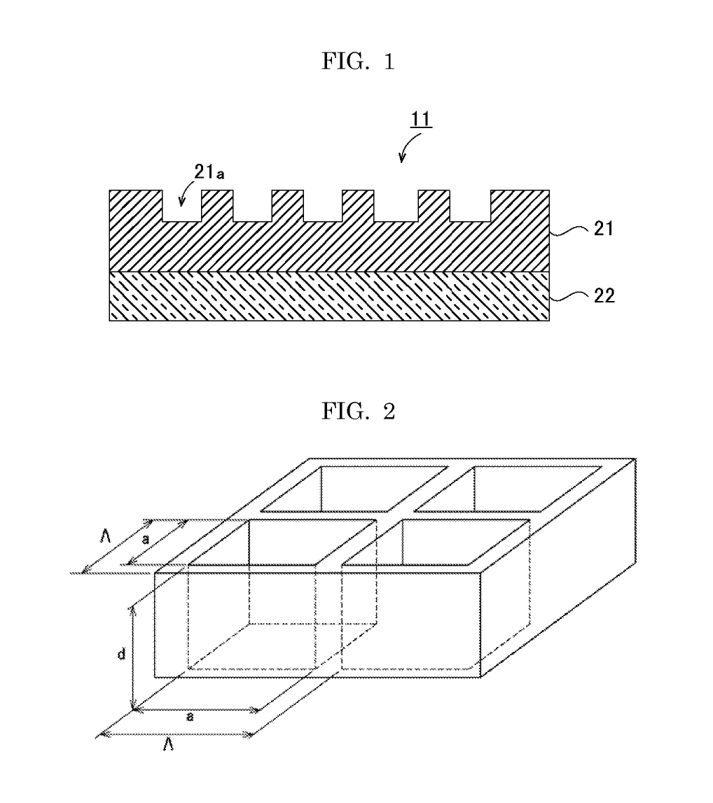

FIG. 1 is a schematic cross-sectional view illustrating a first structural example of the heat radiation control element. The heat radiation control element 11 contains an inorganic layer 21 a surface of which has openings arranged two-dimensionally, and a reflecting film 22. The incident sun light passes through the inorganic layer 21, and most of the light is reflected by the reflecting film 22, and again passes through the inorganic layer 21 to radiate to the outer space. Moreover, thermal radiation in the infrared region is efficiently performed with the inorganic layer 21.

The inorganic layer 21 is either a quartz layer or a glass layer.

The quartz layer is fused quartz or synthetic quartz formed of SiO₂, and has high transmittance to light of a wide wavelength range.

The glass layer is, for example, non-alkali glass, or borosilicate glass, and has high transmittance to light of a wide wavelength range.

The openings 21a are holes, which are called cavities, and are two-dimensionally arranged at a surface of the inorganic layer 21. The two-dimensional arrangement may be a regular arrangement or irregular arrangement, but it is preferably a lattice arrangement, or a houndstooth arrangement, as a high planar filling factor can be attained in such arrangements.

The opening shapes of the openings 21a are ideally highly symmetric shapes, and are preferably circles or regular polygons. When the opening shapes are ovals, rectangles, or parallelograms, there is selectivity to polarized light, and radiation of the polarized light is varied depending on the wavelength. Therefore, the wavelength selectivity of the emittance is low.

FIG. 2 is a schematic perspective view illustrating a structural example of the heat radiation control element where the opening shapes of the openings are squares. These openings are rectangles, and are arranged periodically and symmetrically in an x-axis direction and a y-axis direction. In FIG. 2, A represents a period in the structure, a represents an opening size, and d represents a depth.

The opening diameters a of the openings are preferably 3 μm to 11 μm. When the opening diameters are within this range, it is possible to attain a radiative coefficient (emittance) of 0.9 or greater. The opening diameters a of the openings are determined as a width W of one side in case of squares, but they are determined as diameters D in case of circles. Specifically, the opening diameters of the openings are diameters in the case where the opening shapes are circles, and are diameters of inscribed circles in the case where the opening shapes are regular polygons.

Moreover, the depths d of the openings are preferably 0.7 μm or greater, more preferably 1.0 μm or greater. The emittance can be improved by increasing the depths d of the openings.

Moreover, the aspect ratio (d/a) of the openings is preferably 0.2 or greater, more preferably 0.5 to 3.0. When the aspect ratio is too small, the obtainable result is the same as the case where there are no openings formed at the surface. When the aspect ratio is too large, it is difficult to form deep openings. Moreover, the thermal radiation properties are saturated at a certain depth or greater, and hence it is not necessary to form excessively deep openings.

The reflecting film 22 is provided on the opposite side of the inorganic layer 21 to the side thereof where the openings are formed. When the reflecting film 22 is provided at the side of the inorganic layer 21 where the openings are formed, an effect obtainable by resonances of the openings is reduced, and excellent thermal radiation properties cannot be obtained.

A material of the reflecting film 22 is not particularly limited, as long as it is a material having high reflectance to sun light. Examples thereof include a single metal (e.g., Ag, Cu, Al, Mo, Cr, Ti, Ni, W, and Fe), an alloy containing any of the above-listed metals, and a semiconductor material (e.g., Si, Ge, and Te).

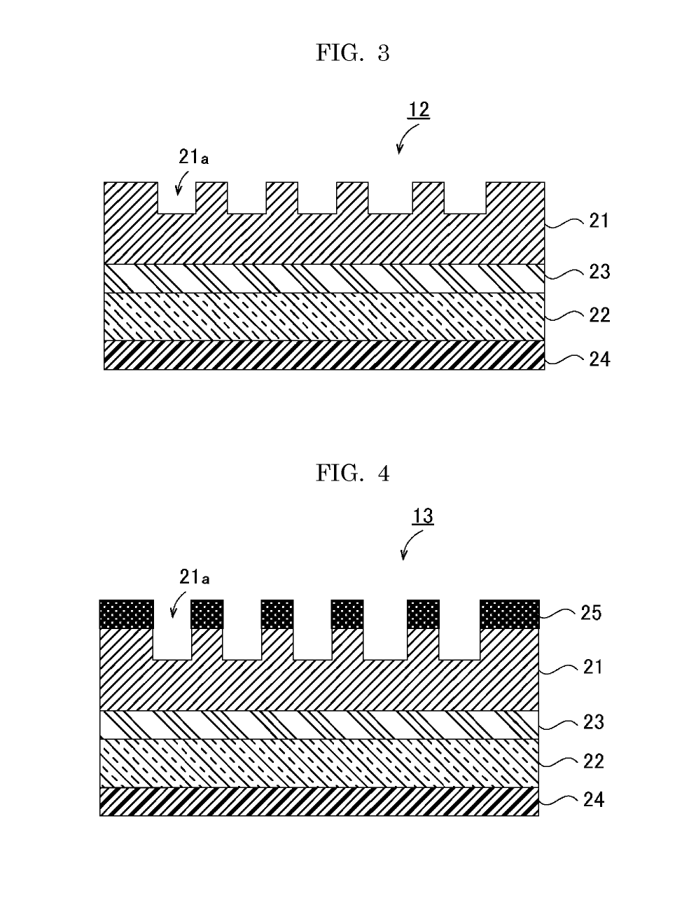

FIG. 3 is a schematic cross-sectional view of the second structural example of the heat radiation control element. The heat radiation control element 12 contains, in addition to the structure of the first structural example of the heat radiation control element 11, a dielectric reflecting film 23, in which a plurality of dielectric films having mutually different refractive indexes are laminated, between the inorganic layer 21 and the reflecting film 22, and a protective film 24 provided on an opposite side of the reflecting film 22 that is the side thereof where the inorganic layer 21 is provided.

In the dielectric reflecting film 23, a plurality of dielectric films having mutually different refractive indexes are laminated. The sun light absorptivity of the heat radiation control element can be reduced by setting the reflectance of the dielectric reflecting film high in the certain wavelength region at which the reflectance of the reflecting film 22 is low.

The protective film 24 is formed of a metal (e.g., Cr, and Ni), or an oxide (e.g., SiO₂, and Al₂O₃), and is configured to protect the reflecting film 22. As a result, the reflecting film 22 is protected from being damaged, and letting sun light pass through.

FIG. 4 is a schematic cross-sectional view illustrating the third structural example of the heat radiation control element, and FIG. 5 is a schematic cross-sectional view illustrating the fourth structural example of the heat radiation control element. These heat radiation control elements 13, 14 each further contain a transparent conducting film 25 or 26 on a surface of the inorganic layer 21 where the openings 21a are provided, in addition to the structure of the second structural example of the heat radiation control element 12.

The transparent conducting film 25 or 26 may not be formed on the side surfaces and bottom surfaces of the openings as in the third structural example, or may be formed on the side surfaces and bottom surfaces of the openings as in the fourth structural example. As for the transparent conducting films 25, 26, a zinc oxide-based transparent conducting film, an indium oxide-based transparent conducting film, or a tin oxide-based transparent conducting film can be used. Since the transparent conducting films 25, 26 let visible rays pass through, and reflect near infrared rays and mid-wavelength infrared rays, excellent heat radiation properties can be attained.

The heat radiation control element having the aforementioned structure can improve the emittance in a certain wavelength region due to the properties unique to a quartz substrate or glass substrate, and excellent thermal radiation properties can be attained, as two-dimensionally arranged opening are provided at a surface of the quartz or glass. In the case where the heat radiation control element is applied to an artificial satellite, for example, a number of electronic equipment loaded inside the artificial satellite can be increased because of a heat balance between heat generated from the electronic equipment inside the artificial satellite and heat radiating from the heat radiation control element. As a result, more functions can be provided to one artificial satellite. Moreover, a number of the heat radiation control elements loaded can be reduced by the improvement of the emittance, hence down-sizing and weight-reduction of the artificial satellite can be achieved.

### 1-2. Radiation Properties Unique to Inorganic (Quartz, and Glass) Substrate

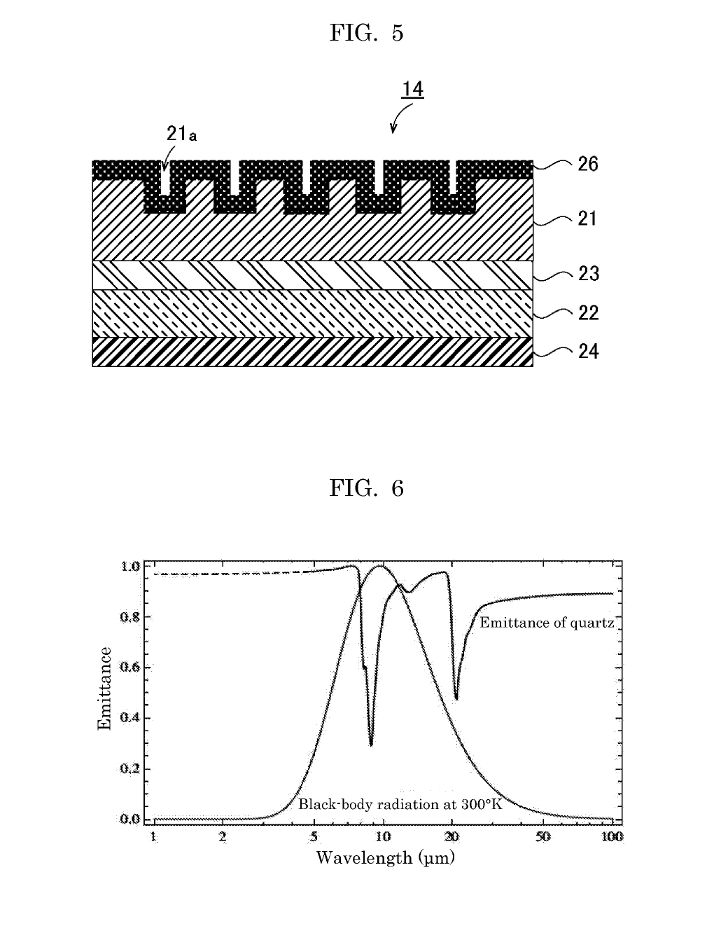

FIG. 6 is a graph depicting the emittance of quartz, and a black-body radiation spectrum. As depicted in FIG. 6, the emittance of the quartz is relatively high in the infrared light region, but it is low in the peak wavelength region of the black-body radiation at 300° K. The reason for this is due to the refractive index of the quartz. The same tendency can be observed with glass.

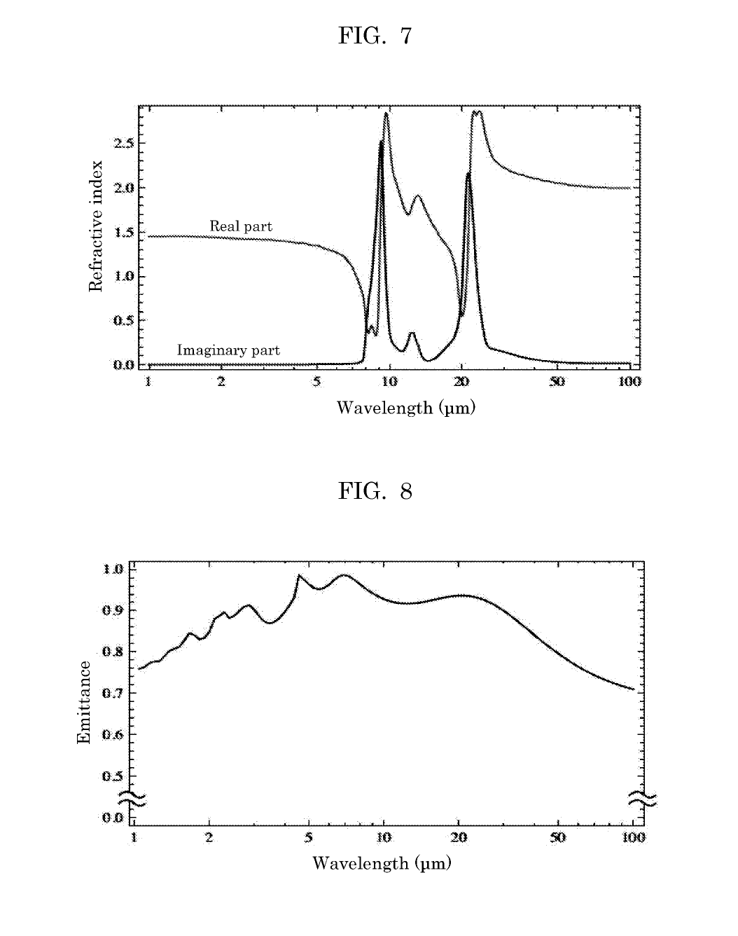

FIG. 7 is a graph depicting a refractive index of quartz. The imaginary part of the refractive index of quartz increases at the wavelength of around 9 μm and at around 23 μm due to the absorption related to the molecular vibration. Therefore, the quartz itself absorbs the light of this wavelength range to reduce the emittance. The same tendency is observed with glass.

The spectrum of the molecular vibration is complicated, not like a wide and smooth spectrum of free electrons of a metal. It has been considered that a resonance of cavities does not occur in a transparent material. Only limited in the narrow wavelength range of the molecular vibration, however, a resonance similar to that of a metal seems to occur.

### 1-3. Resonance of Cavities at Metal Surface

It has been already known that emittance is controlled by providing cavities to a surface of a material having strong absorption, such as a metal.

Inside the cavity, there is a mode of electromagnetic waves locally existing. In case of a metal, the local mode is excited by the thermal energy (thermal vibration) of free electrons inside. Moreover, the local mode causes a resonance with the transmitted light at a certain wavelength, and the energy is passed from the local mode to the transmitted light. As a result, it can explain that the radiation is increased when cavities are formed at a surface of a metal.

Since a resonance occurs only at a certain wavelength, there is the selectivity of the wavelength of radiation. It can be said that a resonance occurs when a size of each cavity is approximately larger than a half the wavelength. Actually, the wavelength at which a resonance occurs and the strength thereof depend on a refractive index of the material or a shape of each cavity, and thus it is necessary to precisely carry out numerical computation.

In order to contribute to radiation, a presence of an imaginary part (extinction coefficient k) of the refractive index of the material is particularly important. In case of a metal, the thermal vibration of free electrons is coupled with light having a wavelength that is longer than a wavelength corresponding to the plasma frequency ωₚ. This means that the energy transfers between the thermal energy and the light inside the metal. Optically, this corresponds that the imaginary part of the refractive index is not 0.

To explain specifically, radiation increases through the following steps 1 to 5.

1. Free electrons are vibrated by heat inside the metal.

2. Light is excited inside the metal by the vibration of the free electrons.

3. The local mode inside the cavity is excited by the light.

4. The local mode causes a resonance with the transmitted light at a certain wavelength.

5. Finally, the transmitted light radiates the thermal energy inside the metal to the outside.

A material always has dispersion, i.e., the wavelength dependency of a refractive index. A spectrum of radiation significantly changes depending on a resonance of cavities, and a refractive index value at the wavelength. In order to qualitatively determine at which wavelength a resonance occurs with a single cavity, it is assumed here that there is no dispersion.

FIG. 8 is a graph depicting the emittance when it is assumed that there is no dispersion. This graph was formed by calculating the emittance when the real part of the refractive index was 2.6764, the imaginary part of the refractive index was 1.5567, a width of each cavity was 3.5 μm, a depth of each cavity was 3.5 μm, and a pitch was 4.5 μm.

As illustrated in FIG. 8, the spectrum of radiation has a very complicated profile. FIG. 8 depicts the calculation results with the aforementioned parameters, but the spectrum of radiation never becomes a flat profile.

### 1-4. Resonance of Cavities at Inorganic (Quartz and Glass) Surface

To increase radiation with cavities at a surface of a metal, a presence of free electrons inside the metal is important. Optically, it is important that the imaginary part of the refractive index is not 0 because of the presence of free electrons.

In a transparent material (the imaginary part of the refractive index is 0), such as quartz, and glass, vibration (most of it is lattice vibration) by heat is not coupled with light transmitting inside, and thus the light can travel inside the material without turning into thermal motion. Namely, the material is transparent. Accordingly, the local mode of the electric field in the cavity is not excited, and the presence of cavities does not largely affect radiation. Specifically, the aforementioned steps 1 and 2 do not exist.

However, with the quartz and glass, there is a wavelength range at which the imaginary part of the refractive index is not 0 within the infrared light region. This is due to molecular vibration, but not the vibration of free electrons as in a metal. The wavelength regions of the molecular vibration are limited, and the wavelength regions are wavelengths of around 9 μm and around 23 μm of the refractive index illustrated in FIG. 7.

At the wavelengths of around 9 μm and around 23 μm, the molecular vibration inside the quartz is coupled with light. If cavities are present at a surface of the quartz, it is considered that the local mode of the electric field in the cavity is excited, and the wavelength thereof is a wavelength at which a resonance occurs, then energy is passed to the transmitted light. It is assumed that the same tendency can be observed with glass.

Specifically, the emittance, particularly that at the wavelength region, where the emittance reduces in case of a flat surface, can be improved by providing cavities at a surface of the quartz or glass. On the other hand, providing cavities does not make any change at other wavelength regions.

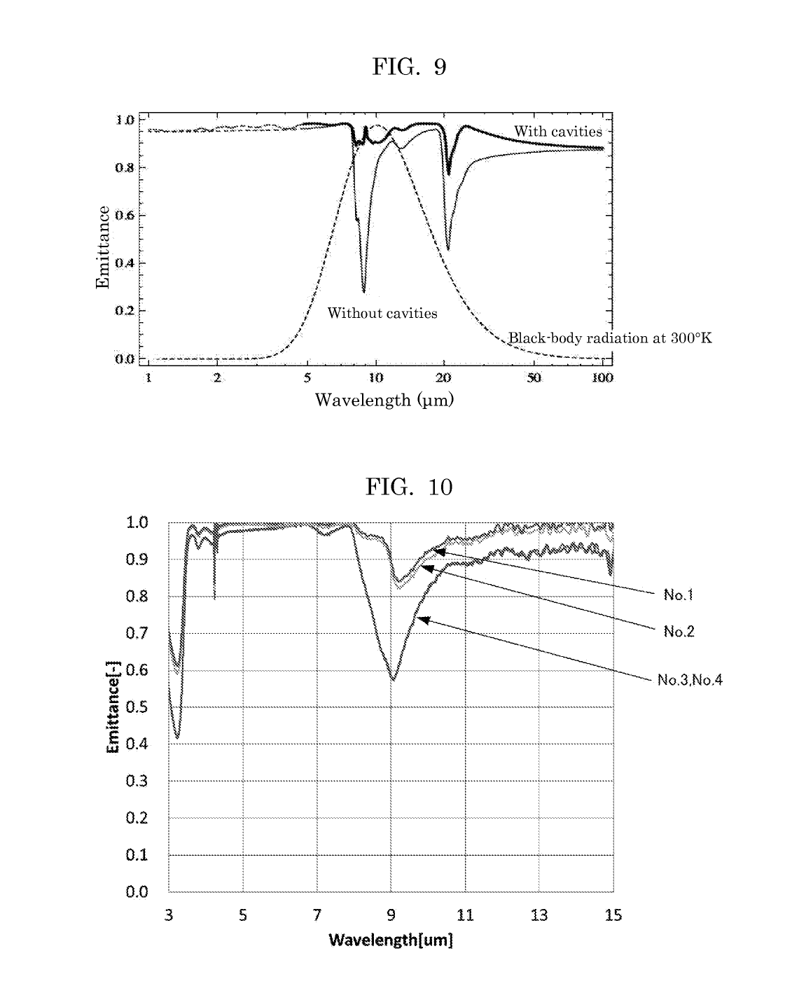

FIG. 9 is a graph depicting the emittance, when cavities are formed at a surface of quartz. This graph was formed by calculating emittance by RCWA when the cavities of the lattice arrangement as illustrated in FIG. 2 each had a width a of 3.5 μm, a pitch Λ of 4.5 and a depth of 3.5 μm.

It can be understood that the emittance is increased by the resonance of the cavities in the wavelength range (especially around 9 μm) where the emittance is reduced by the molecular vibration. The normal emittance ∈ₙ at 300° K for this emittance is about 0.962, and it can be seen that it is improved by 10% or more by providing the cavities.

Table 1 depicts the normal emittance ∈ₙ at 200° K, 300° K, and 400° K.

TABLE 1

| | 200° K | 300° K | 400° K |
|---|---|---|---|
| Without cavities | 0.846 | 0.846 | 0.846 |
| With cavities | 0.956 | 0.962 | 0.967 |

As depicted in Table 1, without cavities, the normal emittance ∈ₙ at 200° K, 300° K, and 400° K were respectively 0.846, 0.846, and 0.846. On the other hand, with cavities, the normal emittance ∈ₙ at 200° K, 300° K, and 400° K were respectively 0.956, 0.962, and 0.967.

As described above, the emittance could be improved by providing the cavities. It is considered that this is because the energy of the molecular vibration is coupled with the light of the radiation mode (transmitted light) by the cavities, to improve the emittance in the certain wavelength region originated to the properties unique to the quartz substrate. The same tendency can be observed with the glass substrate. Examples of samples each prepared by forming cavities at a surface of a glass (TEMPAX, manufactured by SCHOTT AG) substrate, and measurement values thereof are presented below.

FIG. 10 is a graph depicting the emittance of samples (Nos. 1 and 2) prepared by forming cavities at a surface of glass (TEMPAX, manufactured by SCHOTT AG).

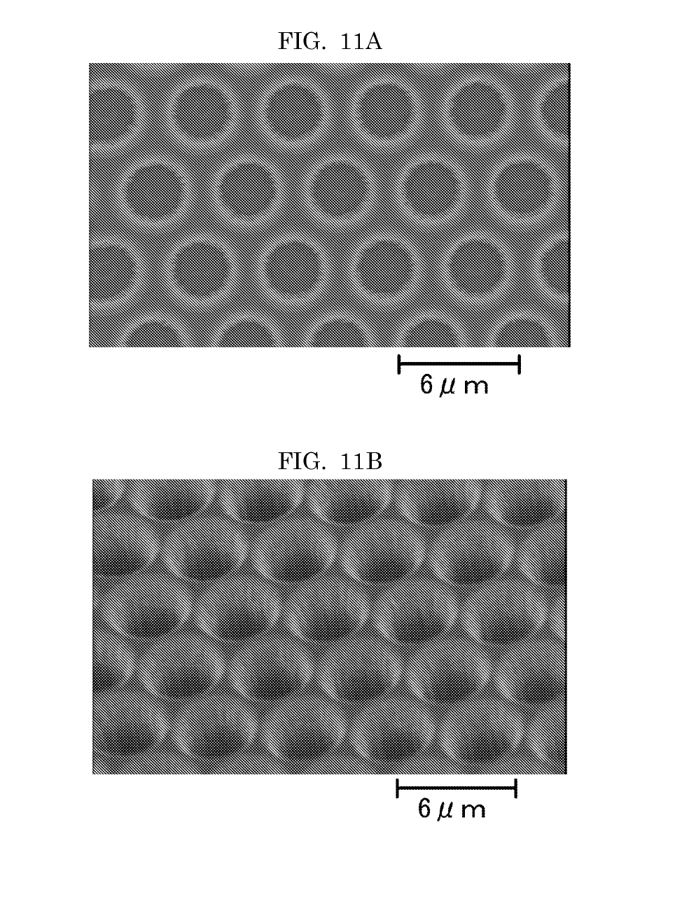

In this graph, Nos. 1 and 2 represent the emittance, which is actually measured on the actually prepared two samples, in which the cavities of the houndstooth arrangement illustrated in FIGS. 11A and 11B each have a width a of 3.2 μm, a pitch Λ of 4.5 μm, and a depth of 3.5 μm. Specifically, the two samples of the same conditions were produced and evaluated in order to confirm reproducibility.

Nos. 3 and 4 in this graph represent the emittance, which is actually measured on the actually prepared two samples each having a flat structure, where no cavity is formed at a surface of glass (TEMPAX, manufactured by SCHOTT AG). Specifically, the two samples of the same conditions were produced and evaluated in order to confirm reproducibility.

Nos. 3 and 4 exhibited the same radiative behaviors. Therefore, the radiation curves thereof are overlapped.

It can be seen that the emittance at the wavelength range (particularly around 9 μm), where the emittance of the glass is reduced by the molecular vibration, is increased by the resonance of the cavities. The normal emittance ∈ₙ of the sample No. 1 at 300° K is about 0.968, and the normal emittance ∈ₙ of the sample No. 2 at 300° K is about 0.956. It is therefore understood that the normal emittance is improved by 10% or greater by providing the cavities.

Table 2 depicts the normal emittance ∈ₙ of Nos. 1 to 4 of FIG. 10 at 300° K.

TABLE 2

| Sample | Normal emittance |
|---|---|
| No. 1 | 0.968 |
| No. 2 | 0.956 |
| No. 3 | 0.880 |
| No. 4 | 0.880 |

The cavities provided at a surface of a metal are configured to narrow a wide radiation spectrum due to free electrons, with utilizing a wavelength selectivity the cavities have. The cavities provided at a surface of quartz or glass are configured to couple the energy of the molecular vibration to the light of the radiation mode (transmitted light). So far, it has been considered that a resonance of cavities does not occur in a transparent material. It is a novel insight that, if the attention is focused on the molecular vibration, the cavities provided at a surface of quartz or glass causes a resonance as in the metal and behave the same way, only in the narrow wavelength range of the molecular vibration.

### 1-5. Widths of Cavities

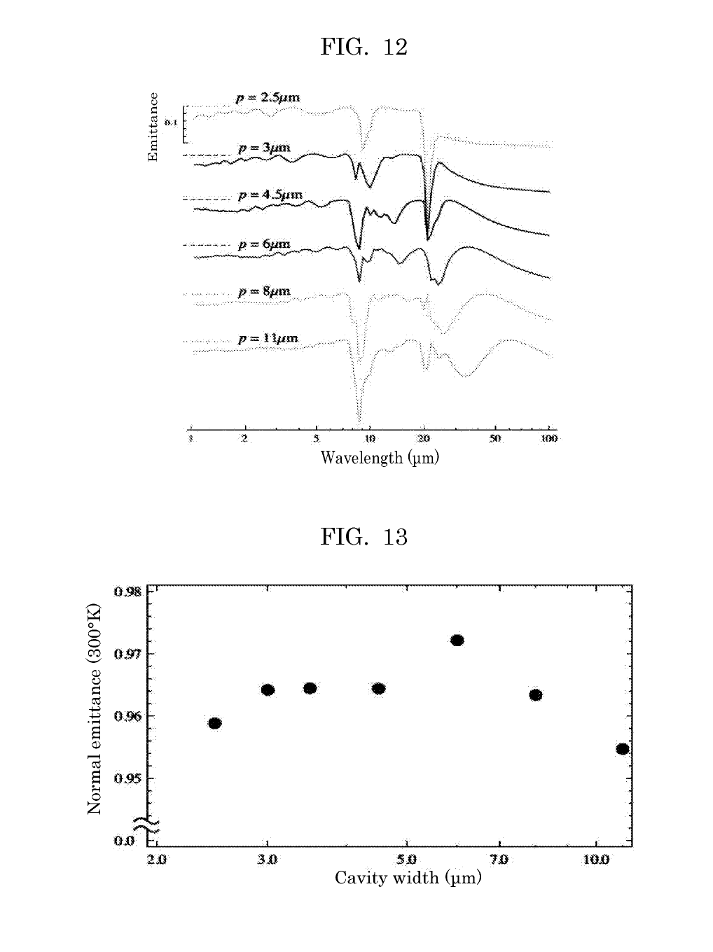

FIG. 12 is a graph depicting the emittance, when widths of cavities formed at a surface of quartz are 2.5 μm, 3.0 μm, 4.5 μm, 6.0 μm, 8.0 μm, and 11.0 μm. The graph was formed by calculating the emittance by RCWA when the cavities of the lattice arrangement as illustrated in FIG. 2 each had the depth that was the same to the width (aspect ratio (d/a)=1), and a pitch that was 1.28 times the length of the width (width a: 3.5 μm, pitch Λ: 4.5 μm). In the case where the cavities have large widths a, the depths d are also large, and a thickness of the area that is a wall and excluded from a cavity is also large. Note that, in FIG. 12, the emittance for each cavity is presented by sliding from the others in the longitudinal direction. Moreover, the emittance of 0.1 is a scale for the left side, and a line for the emittance of 1.0 is presented as a dashed line.

Moreover, FIG. 13 is a graph depicting the normal emittance (300° K) relative to the width of each cavity at the quartz surface. This graph was formed by calculating the normal emittance at 300° K from each emittance spectrum depicted in FIG. 12, and plotting per the cavity width. As depicted in FIG. 13, the maximum value of the normal emittance appears at the cavity width of 6 μm. This is because the wavelength at which a resonance occurs when the cavity width is 6 μm, and a peak of the dispersion of the quartz are coincidentally matched to give a significantly high value. More specifically studying the depth of each cavity, there are parts in the graph where the normal emittance is high, or low, even with the width of around 6 μm.

It can be understood from the graph of FIG. 13 that, in an approximate region of 3 μm to 11 μm, the normal emittance is 0.96 or greater, and the effect obtainable by the cavities is high. In the region where the width of the cavity is larger, the normal emittance reduces, and moreover it is also difficult to form cavities of large depths.

### 1-6. Depths of Cavities

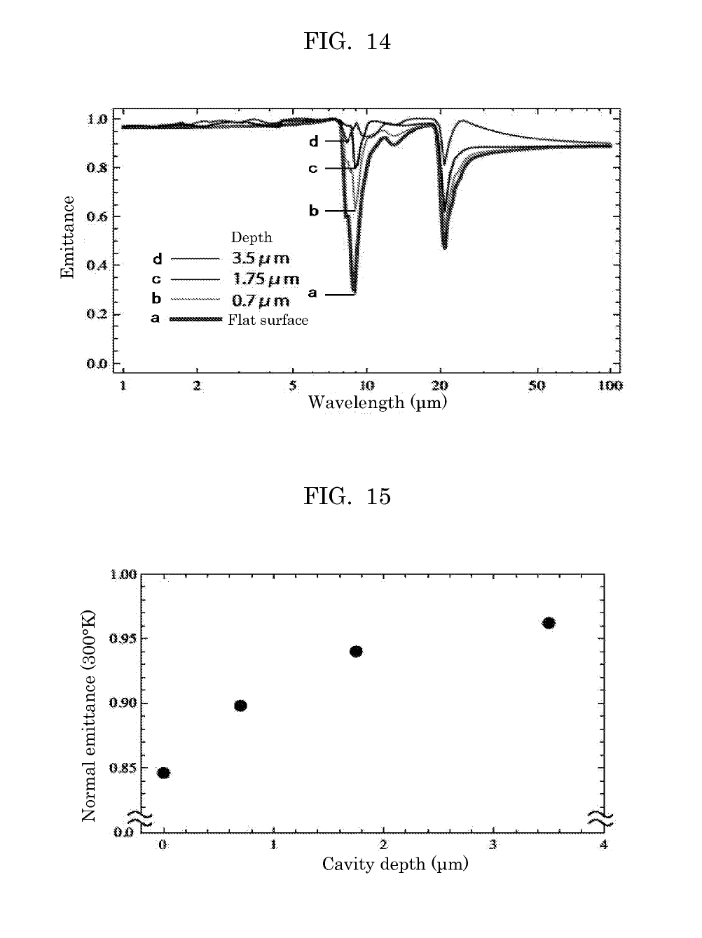

FIG. 14 is a graph depicting the emittance, when the depths of the cavities at a surface of the quartz are 0 μm (flat surface a), 0.7 μm (b), 1.75 μm (c), and 3.5 μm (d). The graph was formed by calculating the emittance by RCWA when the cavities of the lattice arrangement as illustrated in FIG. 2 each had a width a of 3.5 μm, a pitch Λ of 4.5 μm, and a depth d of 0 μm (a flat surface), 0.7 μm (aspect ratio: 0.2), 1.75 μm (aspect ratio: 0.5), or 3.5 μm (aspect ratio: 1.0).

Moreover, FIG. 15 is a graph depicting the normal emittance (300° K) relative to the depths of the cavities at the surface of quartz. This graph was attained by calculating the normal emittance at 300° K from each emittance spectrum depicted in FIG. 14, and plotting per each depth of the cavities.

Moreover, Table 3 depicts the depths of the cavities, the aspect ratio, and the normal emittance.

TABLE 3

| | | |
|---|---|---|
| Depth of cavities | Aspect ratio | Normal emittance |

| | | | |
|---|---|---|---|
| 3.5 | μm | 1.0 | 0.962 |
| 1.75 | μm | 0.5 | 0.940 |
| 0.7 | μm | 0.2 | 0.898 |
| 0.0 | μm | 0.0 | 0.846 |

It can be understood from FIGS. 14 and 15, and Table 3 that the emittance and normal emittance reduce as the depths of the cavities are smaller, and they return back to the state in the case where a surface is a flat surface. On the other hand, it is understood that the normal emittance becomes constant at the certain depth, as the depths of the cavities increase.

Moreover, it is understood that the normal emittance is significantly improved when the depths of the openings are 0.7 μm or greater, compared to the normal emittance in case of a flat surface. Moreover, it is understood that the normal emittance is significantly improved when the aspect ratio is 0.2 or greater, compared to the normal emittance in case of a flat surface.

### 1-7. Pitch of Cavities

The pitch of the cavities seems to have an optimal value relative to a width of each cavity. Here, the electric field inside the cavity is considered.

FIG. 16 is a cross-sectional view schematically illustrating an electric field within a cavity when an imaginary part is infinite. FIG. 17 is a cross-sectional view schematically illustrating an electric field within a cavity when an imaginary part is finite.

As illustrated in FIG. 16, the amplitude of the electric field E inside the cavity is large, when the imaginary part of the refractive index of the material forming the cavity is infinite, specifically, the material is a material, such as a perfect conductor. However, the electric field E cannot enter the material, only vibration that becomes a node at the side wall of the cavity can exist.

In this case, it is considered that a resonance occurs when the width of each cavity is N/2 (N is an integer) times the wavelength. Even when the cavities are densely arranged (a thickness of a side wall is 0), the electric field E inside each cavity is independent, and all of them contribute to radiation.

However, an imaginary part of a refractive index of a general material is a finite value. As illustrated in FIG. 17, therefore, part of the electric field E enters the material, and is coupled with the electric field E of the adjacent cavity.

In this case, the electric field E is affected by the electric field E of the adjacent cavity. Therefore, the electric field E has less freedom in view of a state thereof (conditions for generating a larger amplitude are more limited), and the emittance is reduced. In the case where the cavity width is just ½ the wavelength, for example, the vibration is caused in a reverse phase, and thus radiation becomes 0 (because the reverse phase is added).

In the aforementioned case, cavities act independently as in the case where the imaginary part of the refractive index is infinite, and emittance is increased, if a wall is thickened by a certain degree, and the entry of the adjacent electric field is sufficiently reduced. However, the surface density of the cavities is reduced by the amount of the thickness of the wall. Therefore, it is considered that radiation is lower than the radiation obtained when the imaginary part of the refractive index is infinite.

From the aforementioned qualitative discussions, it is assumed that the widths of the cavities, the value of the imaginary part of the refractive index of the material, and the pitch (thickness of the side wall) of the cavities are related, and there is an optimal pitch determined by the width and the material. The specific value of the optimal pitch can be attained by numerical computation.

### 1-8. Shapes of Cavities

In the above, a calculation is performed on cubic cavities, each of which has an opening shape of a square. This is because there is less computational complexity in RCWA, as these cavities are highly symmetric and a longitudinal direction and a transverse direction are independent from each other. In practice, however, it is difficult to produce cavities of the aforementioned shapes by a simple method.

When cavities are produced by etching without mechanical processing, opening shapes of the cavities are preferably circles (cylindrical cavities). In the case where the opening shapes thereof are circles, there is high computational complexity, but qualitative discussions thereof are possible.

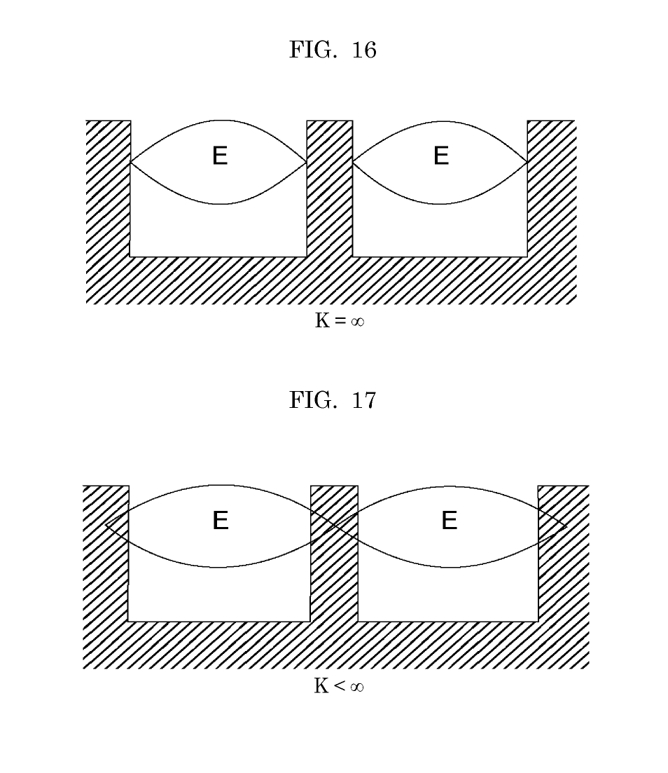

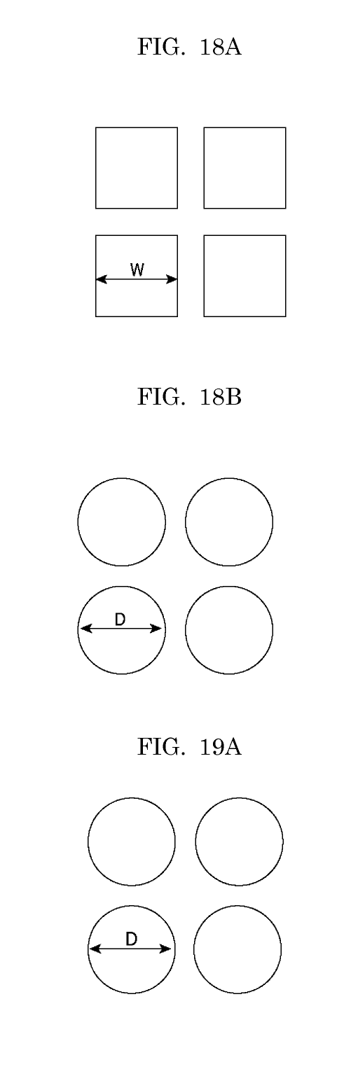

FIG. 18A is a top view illustrating cavities opening shapes of which are squares.

FIG. 18B is a top view illustrating cavities opening shapes of which are circles.

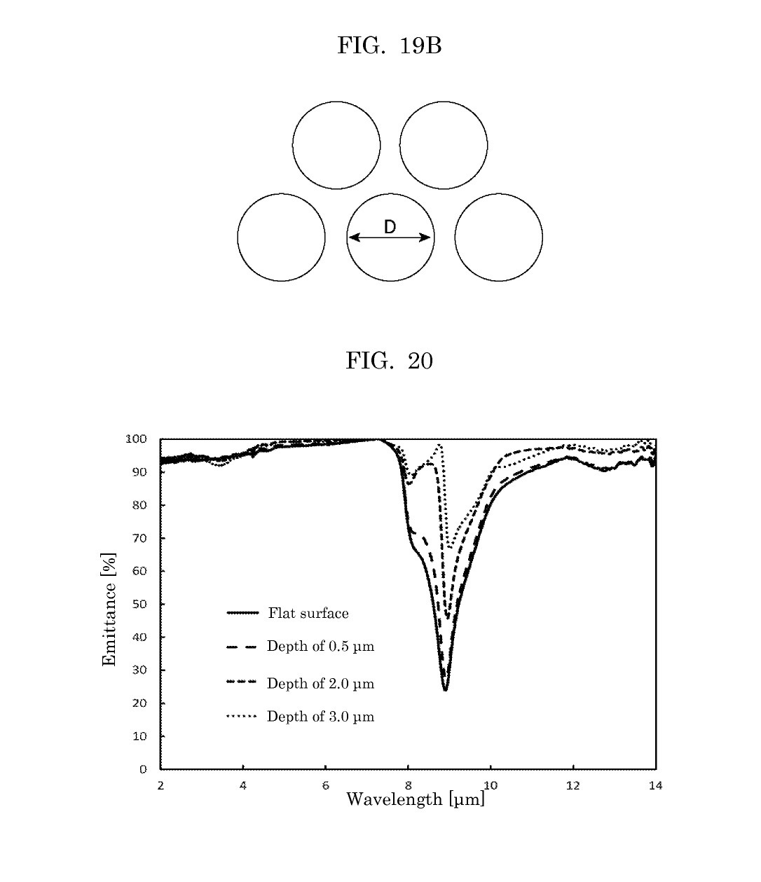

FIG. 19A is a top view illustrating cavities which are arranged in a lattice arrangement.

FIG. 19B is a top view illustrating cavities which are arranged in a houndstooth arrangement.

Considering the qualitative discussions (the electric field inside the cavity) in “1-7. Pitch of cavities,” it is assumed that the same emittance profiles are attained when the opening shapes of the cavities are squares as illustrated in FIG. 18A, and when the opening shapes thereof are circles as illustrated in FIG. 18B. In this case, the width W of the square cavity corresponds to the diameter D of the circular cavity. Accordingly, it can be considered that the numerical range depicted in “1-5. Widths of cavities” corresponds to the range of the diameter in the circular cavity. However, a filling factor of cavities in a flat surface is lower when opening shapes of the cavities are circles, than when opening shapes of the cavities are squares. Therefore, it is considered that emittance is smaller when the opening shapes of the cavities are circles, than when the opening shapes thereof are squares.

In case of circular cavities, a filling factor of the cavities can be increased more with the houndstooth arrangement as illustrated in FIG. 19B, than with the lattice arrangement as illustrated in FIG. 19A, and the emittance can be improved.

FIG. 20 is a graph depicting emittance, when opening shapes of cavities are circles, and depths of the cavities are 0 μm (a flat surface), 0.5 μm, 2.0 μm, and 3.0 μm. The graph was prepared by producing samples each having circular cavities of the houndstooth arrangement illustrated in FIG. 19B, where the diameter D of each cavity at a surface of the quartz was 3.2 μm, the pitch was 4.5 μm, and the depth d was 0 μm (flat surface), 0.5 μm (aspect ratio: 0.16), 2.0 μm (aspect ratio: 0.63), or 3.0 μm (aspect ratio: 0.94), by the below-mentioned first embodiment of the production method, and measuring each samples. Each sample was produced by forming circular cavities in a quartz substrate. Moreover, the emittance was measured using an integrating sphere by FT-IR.

As illustrated in FIG. 20, it was found that the emittance at the wavelength of around 9 μm was improved, similarly to the emittance calculated by RCWA. It was found that the emittance at the wavelength of around 9 μm was improved by increasing the depth of the cavity also in the case where the opening shape was circle, similarly to the case where the opening shape thereof was a square.

Note that, other shapes, such as a rectangle, a parallelogram, an oval, can be considered, but such asymmetric shapes give selectivity to polarized light. Specifically, the polarized light of radiation is polarized depending on a wavelength to thereby lower the selectivity of wavelength. If it is specifically explained, to lower the selectivity of the wavelength means that the curve of the spectrum of the emittance depicted in FIG. 8 becomes gentle. The present technology is to improve the emittance as a whole by combining complicated radiation properties of the quartz or glass with the resonance wavelength of the cavities. If the opening shapes of the cavities are asymmetric, a sharp drop in the emittance of the quartz or glass at the certain wavelength, where the selectivity of the wavelength is low, cannot be sufficiently brought back up. It can be understood from the discussions above that the shapes of the cavities are preferably symmetric shapes.

Moreover, the data obtained by measuring produced actual samples is introduced.

The actual samples to be introduced are each a sample where cavities are formed at a surface of quartz. Shapes of the cavities in the samples are as described in Table 4.

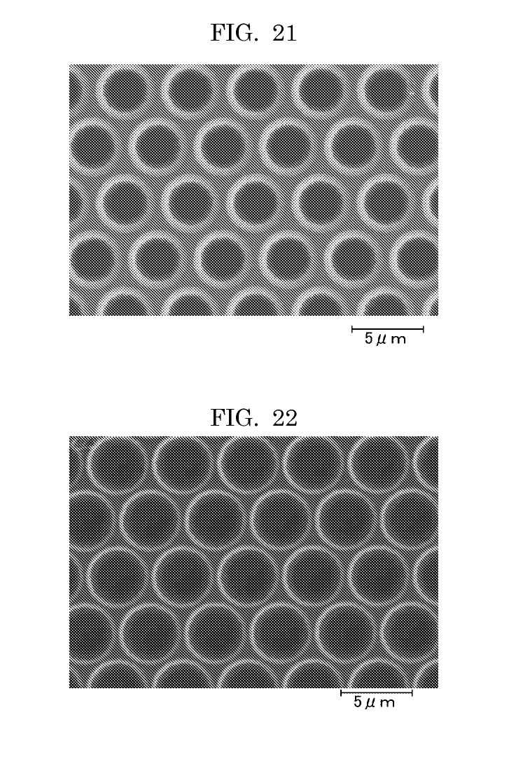

FIG. 21 is a planar photograph of the actual sample that is a sample No. 11 (pitch: 4.5 μm, cavity diameter: 3.0 μm, and cavity depth: 3.5 μm).

FIG. 22 is a planar photograph of the actual sample that is a sample No. 13 (pitch: 4.5 μm, cavity diameter: 4.0 μm, and cavity depth: 3.5 μm).

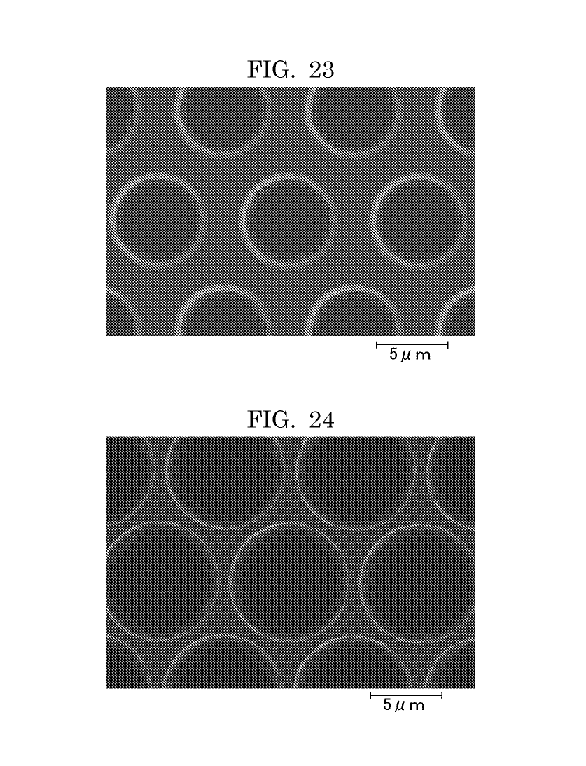

FIG. 23 is a planar photograph of the actual sample that is a sample No. 14 (pitch: 9.0 μm, cavity diameter: 6.0 μm, and cavity depth: 6.5 μm).

FIG. 24 is a planar photograph of the actual sample that is a sample No. 16 (pitch: 9.0 cavity diameter: 8.0 and cavity depth: 6.5 μm).

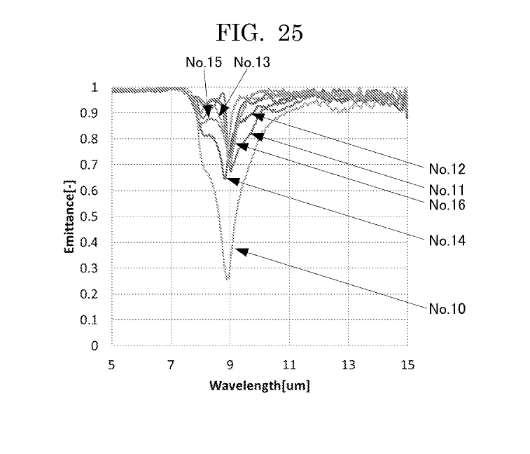

The emittance properties of the plate-shaped quartz substrate (No. 10), and the actual samples Nos. 11 to 16 were investigated. The results are depicted in FIG. 25. It was confirmed that the emittance properties to light having the wavelength of around 9 μm could be improved by forming the cavity structure. Moreover, the infrared emittance properties in the wavelength range of 5 μm to 15 μm are presented in Table 4. Whereas the infrared emittance of the flat sample (No. 10) was 0.847, the infrared emittance of the cavity samples (No. 11 to No. 16) were 0.926 or greater. It was therefore confirmed that the infrared emittance properties are improved with the cavity samples.

Moreover, it could be confirmed from the infrared emittance properties when a ratio of the cavity diameter to the pitch was 0.7, 0.8, or 0.9, that the infrared emittance was higher when the cavity diameter was larger (ratio: 0.9), with both pitches of 4.5 μm, and 9.0 μm.

TABLE 4

| | | | Ratio | | Infrared emit- |
|---|---|---|---|---|---|
| | | Diameter | (cavity | Depth of | tance of wave- |
| | Pitch | of cavity | diameter/ | cavity | length range of |
| Sample | [μm] | [μm] | pitch) | [μm] | 5 μm to 15 μm |
| No. 10 | (plate) | | | | 0.847 |
| No. 11 | 4.5 | 3.0 | 0.7 | 3.5 | 0.926 |
| No. 12 | | 3.5 | 0.8 | | 0.951 |
| No. 13 | | 4.0 | 0.9 | | 0.960 |
| No. 14 | 9.0 | 6.0 | 0.7 | 6.5 | 0.929 |
| No. 15 | | 7.0 | 0.8 | | 0.947 |
| No. 16 | | 8.0 | 0.9 | | 0.956 |

As explained above, the heat radiation control element of the present embodiment can improve emittance in a certain wavelength range due to the properties unique to the quartz substrate or glass substrate, and have excellent thermal radiation properties.

### 2. Production Method of Heat Radiation Control Element

### 2-1. First Embodiment

The production method of a heat radiation control element according to the first embodiment: forming a resist pattern, in which predetermined shapes are two-dimensionally arranged, on a surface of an inorganic substrate, which is either a quartz substrate or a glass substrate; etching the surface of the inorganic substrate using the resist pattern as a mask to form two-dimensionally arranged openings at the surface of the inorganic substrate; and forming a reflecting film on a surface of the inorganic substrate that is opposite to the surface thereof where the openings are formed through vacuum deposition or sputtering.

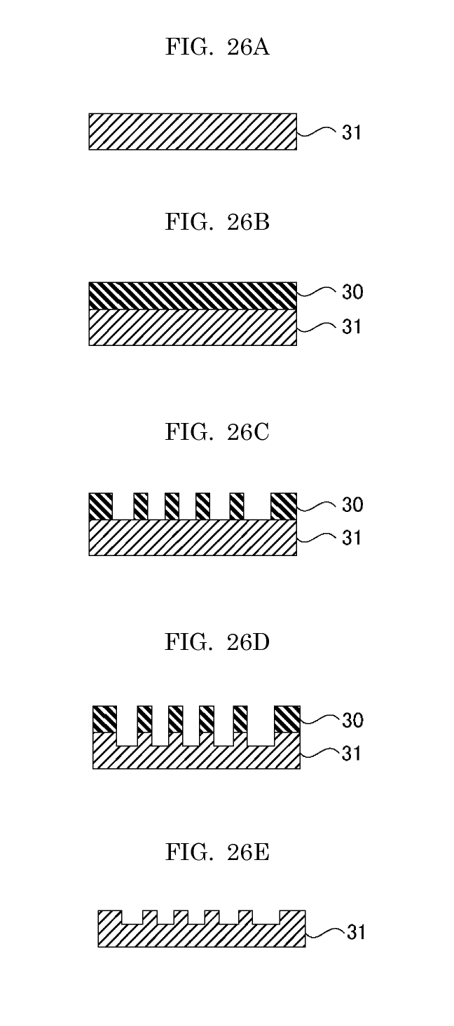

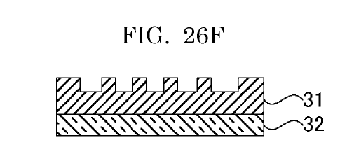

FIGS. 26A to 26F are cross-sectional view for explaining steps of the production method of a heat radiation control element according to the first embodiment. Each of the steps is explained hereinafter.

### [Formation of Resist Pattern]

First, a quartz substrate serving as an inorganic substrate 31 is washed to prepare the inorganic substrate 31 as illustrated in FIG. 26A. A resist 30 is applied onto a surface of the inorganic substrate 31 as illustrated in FIG. 26B. Then, exposure and developing are performed through photolithography, or nano imprinting, to form a precise resist pattern, in which predetermined shapes are two-dimensionally arranged, as illustrated in FIG. 26C.

### [Formation of Openings]

Subsequently, predetermined openings are formed at the surface of the inorganic substrate 31 by performing etching using the resist pattern as a mask, as illustrated in FIG. 26D. Thereafter, the resist pattern used as a mask is removed by ashing or any other methods, as illustrated in FIG. 26E.

### [Formation of Reflecting Film]

Finally, a reflecting film 32 is formed on a back surface of the inorganic substrate 31 to which the openings have been formed by vacuum deposition or sputtering, as illustrated in FIG. 26F. In the manner as described above, a heat radiation control element is obtained.

According to the first embodiment, a heat radiation control element of the first structural example illustrated in FIG. 1 can be produced.

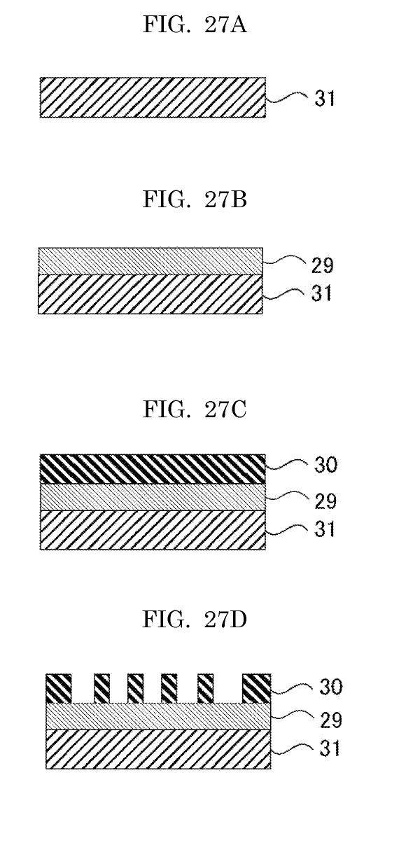

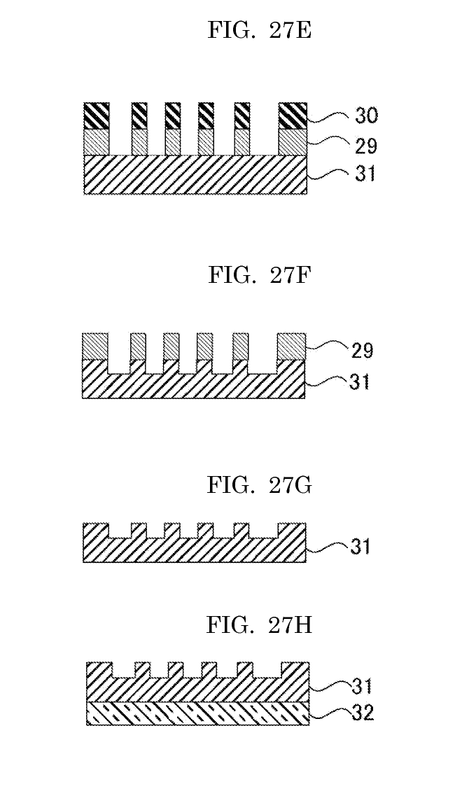

FIGS. 27A to 27H are cross-sectional view for explaining steps of the production method of a heat radiation control element, which is similar to the first embodiment. Each of the steps is explained hereinafter.

### [Formation of Etching Mask]

First, a glass substrate serving as an inorganic substrate 31 is washed to prepare the inorganic substrate 31 as illustrated in FIG. 27A. A metal layer 29 is formed on a surface of the inorganic substrate 31 as illustrated in FIG. 27B. Subsequently, a resist 30 is formed on a surface of the metal layer 29, as illustrated in FIG. 27C. Then, exposure and developing are performed through photolithography, or nano imprinting, to thereby form a precise resist pattern, in which predetermined shapes are two-dimensionally arranged, as illustrated in FIG. 27D. Moreover, etching is performed on the metal layer 29 using the precise resist pattern as a mask, to thereby obtain the metal layer 29 (etching mask) having the precise resist pattern where the predetermined shapes are two-dimensionally arranged (FIG. 27E). Then, the resist pattern is removed.

Examples of a material of the metal layer 29 include Ni, Cr, Al, Ti, Ta, Cu, Au, and a composite material containing any of the above-listed materials.

### [Formation of Openings]

Next, predetermined openings are formed at a surface of the inorganic substrate 31 through etching performed over the etching mask, as illustrated in FIG. 27F. Thereafter, the metal layer 29 used as the etching mask is removed by wet etching or any other methods, as illustrated in FIG. 27G.

Formation of the openings is performed, for example, through dry etching. The gas used for the dry etching is obtained by using Ar as a main gas, and mixing Ar with a radical reaction gas, such as C₄F₈, and CF₄.

### [Formation of Reflecting Film]

Finally, a reflecting film 32 is formed on a back surface of the inorganic substrate 31, to which the openings have been formed, by vacuum deposition or sputtering, as illustrated in FIG. 27H. In the manner as described above, a heat radiation control element is obtained.

According to this embodiment, a heat radiation control element of the first structural example illustrated in FIG. 1 can be produced.

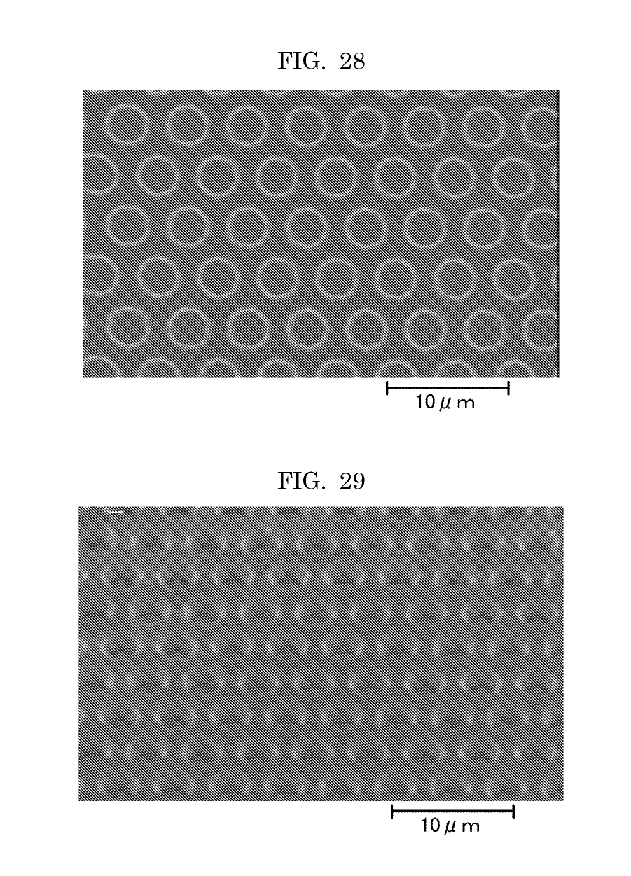

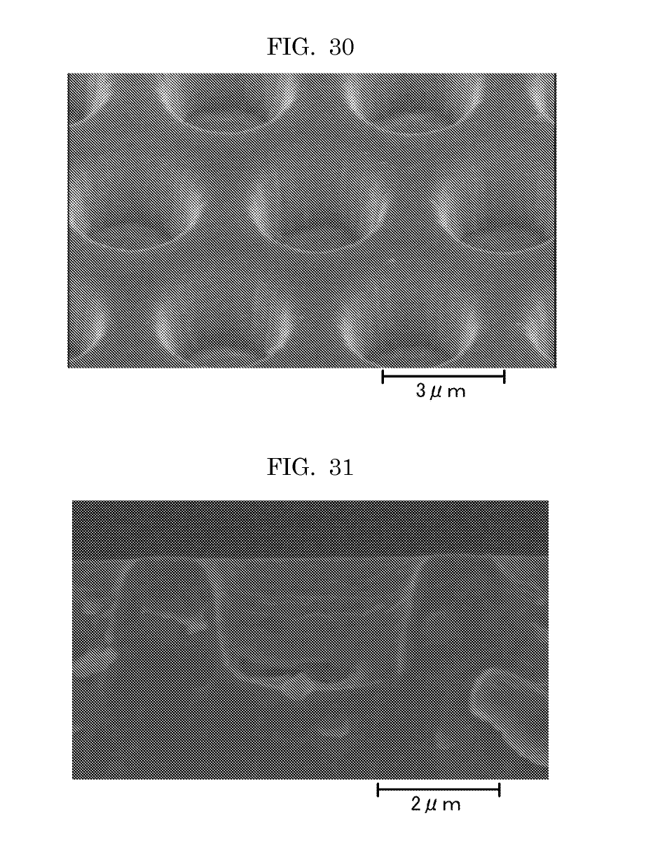

FIGS. 28 to 31 are respectively a planar photograph, 45°-diagonal photograph, 45°-diagonal enlarged photograph, and cross-sectional photograph depicting openings shapes of which are circles having sizes of 4.6 μm in the pitch, 3.2 μm in the diameter, and 2.1 μm in the depth.

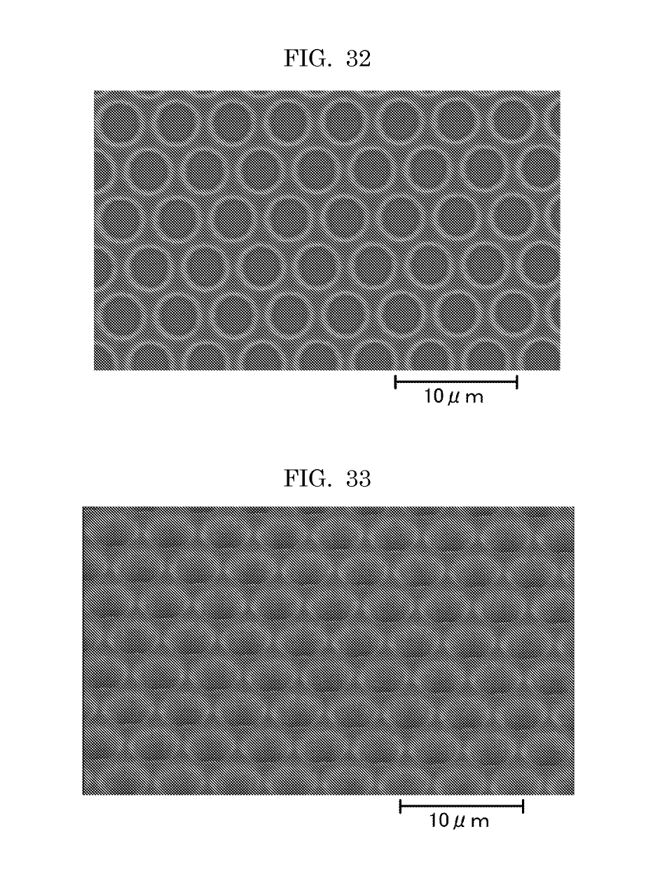

Moreover, FIGS. 32 to 34 are respectively a planar photograph, 45°-diagonal photograph, and 45°-diagonal enlarged photograph depicting openings shapes of which are circles having sizes of 4.6 μm in the pitch, 3.9 μm in the diameter, and 3.5 μm in the depth.

### 2-2. Second Embodiment

The production method of a heat radiation control element according to the second embodiment contains: laminating a dielectric film, a reflecting film, and a protective film in this order on one surface of an inorganic substrate that is either a quartz substrate or a glass substrate; forming a transparent conductive film on another surface of the inorganic substrate; forming a resist pattern, in which predetermined shapes are two-dimensionally arranged, on a surface of the transparent conductive film; and etching the surface of the inorganic substrate using the resist pattern as a mask to form two-dimensionally arranged openings at the surface of the inorganic substrate.

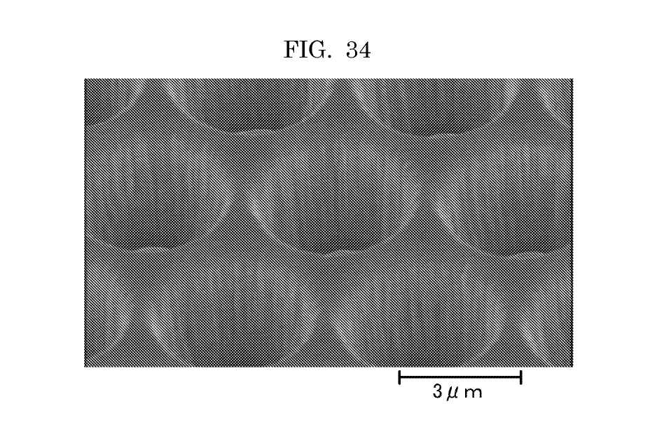

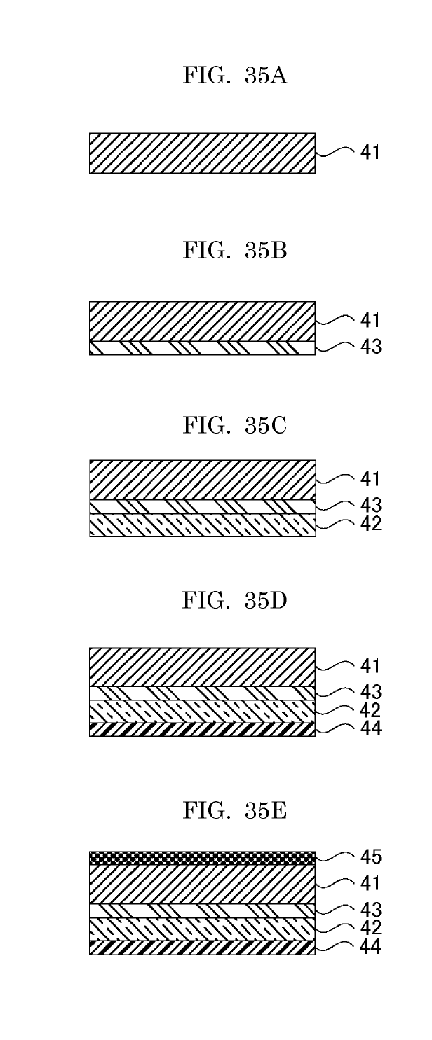

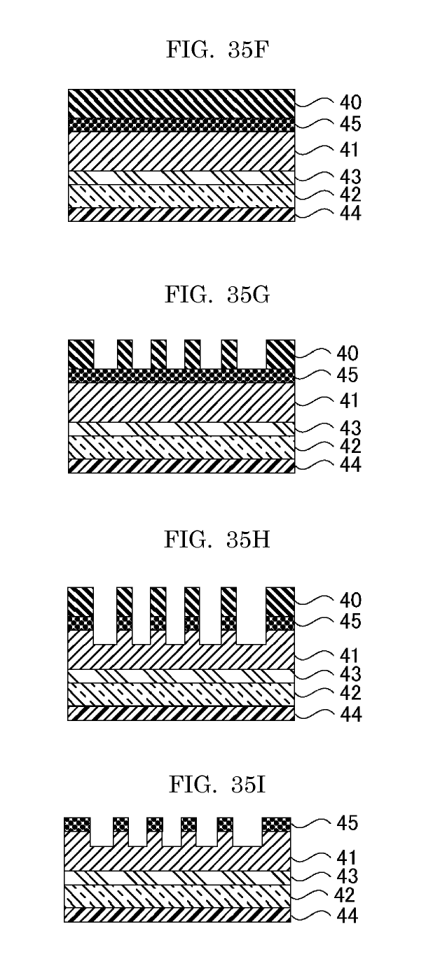

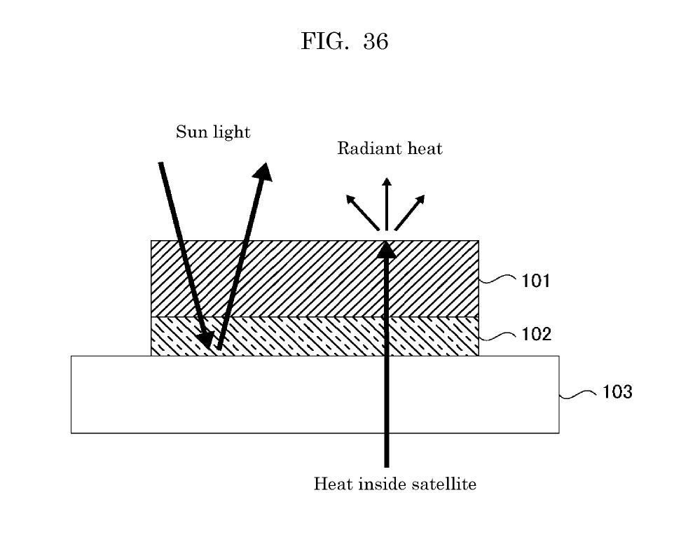

FIGS. 35A to 35I are cross-sectional views for explaining steps of the production method of a heat radiation control element according to the second embodiment. Each of the steps is explained hereinafter.

### [Laminating]

First, a quartz substrate serving as an inorganic substrate 41 is washed to prepare the inorganic substrate 41 as illustrated in FIG. 35A. A dielectric reflecting film 43, which is, for example, formed of SiO₂, and has a thickness of 10 nm or greater, is formed on one side of the inorganic substrate 41 by sputtering, as illustrated in FIG. 35B. Moreover, a reflecting film 42, which is, for example, formed of Ag, and has a thickness of 75 nm or greater, is formed on the dielectric reflecting film 43 by vacuum deposition, as illustrated in FIG. 35C. Moreover, a protective film 44, which is, for example, formed of Cr, and has a thickness of 5 nm or greater, is formed on the reflecting film 42, as illustrated in FIG. 35D.

### [Formation of Transparent Conducting Film]

Next, a transparent conducting film 45, which is, for example, formed of ITO, and has a thickness of 5 nm or greater, is formed on the other side of the inorganic substrate 41 by sputtering or vacuum deposition, as illustrated in FIG. 35E.

### [Formation of Resist Pattern]

Next, a resist 40 is applied onto the transparent conducting film 45, as illustrated in FIG. 35F. Then, exposure and developing are performed through photolithography or nano imprinting, to thereby form a precise resist pattern, in which predetermined shapes are two-dimensionally arranged, as illustrated in FIG. 35G.

### [Formation of Openings]

Next, predetermined opening are formed at the surface of the inorganic substrate 41 by performing etching using the resist pattern as a mask, as illustrated in FIG. 35H. Thereafter, the resist pattern used as a mask is removed by ashing or any other methods, as illustrated in FIG. 35I. In the manner as described above, a heat radiation control element is obtained.

The production method of a heat radiation control element according to the second embodiment can produce a heat radiation control element of the third structural example illustrated in FIG. 4.

### 2-3. Another Embodiment

In the formation of the openings in the first and second embodiments, a passivation mode and an etching mode are alternately performed. The passivation mode is a mode where a side surface protective film having a resistance to wet etching is formed on side walls of the openings of the N stage (N is natural number), and the etching mode is a mode where the bottom surfaces of the openings of the N stage, to which the side surface protective film has been formed, are etched through wet etching to form openings of the N+1 stage. As a result, the shape having a large aspect ratio can be obtained.

In the passivation mode, after forming a surface protective film having a resistance to wet etching on the opening of the N stage (N is a natural number) and the resist pattern, it is preferred that a side surface protective film be formed on side walls of the openings of the N stage, as well as exposing the bottom surfaces of the openings of the N stage through ion etching.

As for the wet etching, electrolytic etching or chemical etching may be used. In the case where the substrate is a metal or ally having high corrosion resistance, or the case where openings having opening diameters (widths) of 20 μm or less are formed, electrolytic etching is preferably used.

Moreover, the ion etching may be performed using Ar ions in a vacuum atmosphere by means of a vacuum device, or in the atmospheric pressure atmosphere by means of an atmospheric pressure plasma device. By ion etching, a side surface protective film can be formed on side walls of the openings of N step (N is a natural number), which have been formed by wet etching. Since the side surface protective film contains a product generated by a reaction of a material, such as the resist material, and a base material of the bottom surface of the opening (etching residues), the side surface protective film has a resistance to wet etching.

By alternately performing the passivation mode and the etching mode after the initial etching mode, the etching can be carried out in the depth direction with suppressing the side etching, and the predetermined opening shapes (high aspect shapes) can be obtained.

This application claims priority to Japanese application No. 2014-019571, filed on Feb. 4, 2014 and incorporated herein by reference, and Japanese application No. 2014-246939, filed on Dec. 5, 2014 and incorporated herein by reference.

What is claimed is:

1. A heat radiation control element, comprising:
an inorganic layer a surface of which has openings arranged two-dimensionally; and
a reflecting film,
wherein the inorganic layer is either a quartz layer, or a glass layer.

2. The heat radiation control element according to claim 1, wherein an opening shape of each of the openings is a circle or a regular polygon.

3. The heat radiation control element according to claim 1, wherein the openings have opening diameters of 3 μm to 11 μm.

4. The heat radiation control element according to claim 1, wherein the openings have depths of 0.7 μm or greater.

5. The heat radiation control element according to claim 1, wherein the openings have an aspect ratio of 0.2 or greater.

6. The heat radiation control element according to claim 1, wherein the two-dimensional arrangement is a lattice arrangement, or a houndstooth arrangement.

7. The heat radiation control element according to claim 1, wherein the reflecting film is provided on an opposite side of the inorganic layer to the side thereof at which the openings are formed.

8. The heat radiation control element according to claim 7, further comprising a dielectric reflecting film between the inorganic layer and the reflecting film, wherein the dielectric reflecting film is a dielectric film of a single layer, or a laminate of dielectric films having mutually different refractive indexes.

9. The heat radiation control element according to claim 7, further comprising a protective film provided at an opposite side of the reflecting film to the side thereof at which the inorganic layer is provided.

10. The heat radiation control element according to claim 7, further comprising a transparent conducting film provided at the side of the inorganic layer where the openings are formed.

11. A production method of a heat radiation control element, comprising:
forming a resist pattern, in which predetermined shapes are two-dimensionally arranged, on a surface of an inorganic substrate, which is either a quartz substrate or a glass substrate;
etching the surface of the inorganic substrate using the resist pattern as a mask to form two-dimensionally arranged openings at the surface of the inorganic substrate; and
forming a reflecting film on a surface of the inorganic substrate that is opposite to the surface thereof where the openings are formed through vacuum deposition or sputtering.

12. A production method of a heat radiation control element, comprising:
laminating a dielectric film, a reflecting film, and a protective film in this order on one surface of an inorganic substrate that is either a quartz substrate or a glass substrate;
forming a transparent conductive film on another surface of the inorganic substrate;
forming a resist pattern, in which predetermined shapes are two-dimensionally arranged, on a surface of the transparent conductive film; and
etching the surface of the inorganic substrate using the resist pattern as a mask to form two-dimensionally arranged openings at the surface of the inorganic substrate.
